(19) United States
(12) Patent Application Publication
(10) Pub. No.: US 2016/0204422 A1
(43) Pub. Date: Jul. 14, 2016

(54) BATTERY ANODE

(71) Applicant: GRAFTECH INTERNATIONAL HOLDINGS INC., Parma, OH (US)

(72) Inventors: Meixian Wang, Solon, OH (US); Haiming Xiao, Copley, OH (US)

(73) Assignee: GrafTech International Holdings Inc., Brooklyn Heights, OH (US)

(21) Appl. No.: 14/912,996

(22) PCT Filed: Aug. 12, 2014
(86) PCT No.: PCT/US14/50655

§ 371 Date: Feb. 19, 2016

Related U.S. Application Data
(60) Provisional application No. 61/867,642, filed on Aug. 20, 2013.

(51) Int. Cl. H01M 4/36; H01M 4/134; H01M 4/66; H01M 10/0525; H01M 4/587; H01M 4/38

(52) U.S. Cl. CPC H01M 4/366; H01M 4/587; H01M 4/386; H01M 4/661; H01M 10/0525; H01M 4/134; H01M 4/663; H01M 4/667; H01M 4/668; H01M 2004/027

(57) ABSTRACT

A battery anode including a metallic current collector layer adjacent a first major surface of a graphite layer and a silicon containing anode layer adjacent a second major surface of the graphite layer. One application for such anode is in a lithium-ion battery.

### BACKGROUND

1. Field

The disclosure relates to an anode for a battery, and more particularly an anode for a lithium ion battery.

2. Related Art

Lithium ion batteries are one type of rechargeable batteries in which lithium ions move between the negative and positive electrode. The lithium ion moves through an electrolyte from the negative to positive electrodes during discharge, and in reverse, from the positive to the negative electrode during recharge. Typically the negative electrode (also known as anode) is formed from graphite, due to it stability during charge and discharge cycles as it forms solid electrolyte interface layers with very small volume change during the charge/discharge cycles.

Typically a battery will include a separator layer between the negative electrode and the positive electrode. The electrolyte may permeate through both of the negative and positive electrodes as well as the separator layer. In some battery configurations, the three (3) layers (positive electrode, separator layer and negative electrode) may be rolled into a cylindrical orientation and are located in a can. Each electrode is typically coated on a thin foil. Usually the positive electrode is coated on aluminum foil, whereas the negative electrode is coated on copper foil.

Lithium ion batteries are finding applications as a power source in portable electronics such as mobile phones, tablets, e-readers, netbooks and lap top computers as well as in automobiles.

3. Brief Description

One embodiment contained herein is a battery anode. The anode includes a metallic current collector layer adjacent a first major surface of a graphite layer and a silicon containing anode layer adjacent a second major surface of the graphite layer. One application for the above type of anode is in a lithium ion battery. An advantage of the disclosed subject matter is that the silicon anodes of the disclosed embodiments will have reduced degradation capacity. Such anodes will also exhibit a reduction in volume expansion.

It is to be understood that both the foregoing general description and the following detailed description provide embodiments of the disclosure and are intended to provide an overview or framework of understanding to nature and character of the invention as it is claimed.

### DESCRIPTION OF DRAWINGS

FIG. 1 is a schematic internal view of a battery.

FIG. 2 is a schematic view of an anode of the present disclosure.

FIG. 3 is a schematic view of a second embodiment of an anode disclosed herein.

FIG. 4 is a chart of the capacity retention percentage vs. the number of charge/discharge cycles.

FIG. 5 is a schematic view of the control anode.

### DETAILED DESCRIPTION

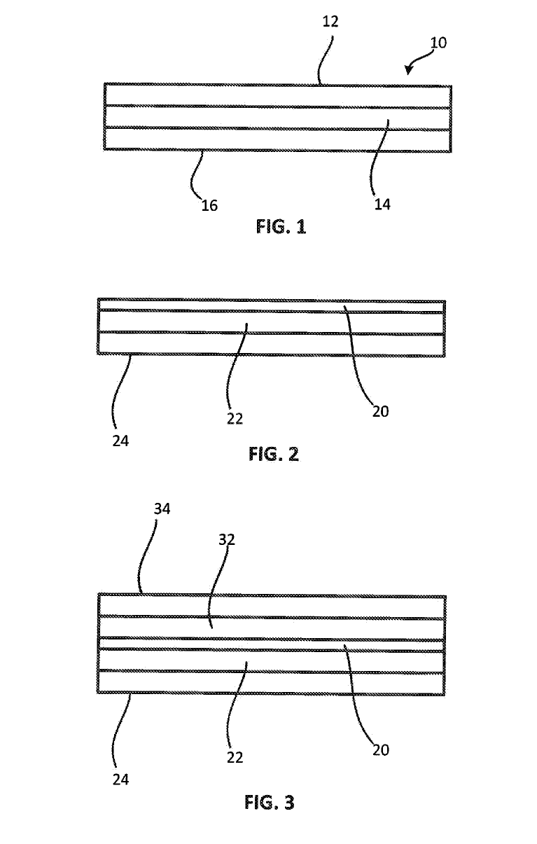

Illustrated in FIG. 1 is a schematic internal view of a battery 10, preferably a lithium ion battery. Battery 10, as shown, includes a cathode 12, a separator 14, an anode 16 and an electrolyte (not shown). Through electrolyte Li-ions are transferred back and forth from cathode 12 and anode 16. Each of the cathode 12, separator 14 and anode 16 are permeable to allow the Li-ions to pass back and forth from cathode 12 and anode 16.

Depicted in FIG. 2 is a schematic view of anode 16. As illustrated, anode 16 includes at least three (3) separate layers. The first layer consists of a copper current collector 20. Current collector 20 may be in the form of a metal foil sheet having two (2) major surfaces. A typical thickness for current collector 20 is less than about 20 microns, further less than about 15 microns, and even further no more than about 10 microns. Current collector 20 is not limited to being constructed from copper. Any suitable material which can function as a current collector may be used; copper is one an example of a material which is suitable for such an application. Typically other metallic materials may be used as the current collector. Parameters for suitable material for current collector 20 include good mechanical strength, high electrical conductivity, and excellent flexibility.

Adjacent a first of the major surfaces of the current collector is a graphite layer 22. The graphite layer also may be in the form of a sheet having two (2) major surfaces. Graphite layer 22 may be bonded to current collector 20; preferably a major surface of each is bonded to together. Suitable binders may include organic or water based binders. Two examples of suitable binders include polyvinylidene fluoride (“PVDF”) and styrene butadiene rubber.

Techniques to apply graphite layer 22 to collector 20 include the application of graphite slurry to one (1) or both sides of collector 20; graphite is cast onto to collector 20 or the graphite slurry is spread onto one side of the collector 20.

An exemplary thickness of graphite layer 22 is at least about 50 microns. Another exemplary thickness is less than about 100 microns. Typically the thickness of the graphite layer is at least about 1 micron to about 150 microns. It is preferred that the thickness of graphite layer 22 is sufficient to avoid peeling off of silicon layer 24, from the rest of anode 16, caused by the volume expansion of the silicon layer 24 during operation of the battery.

Graphite layer 22 is not limited to any particular type of graphite. Graphite layer 22 may include natural graphite, intercalated graphite, exfoliated graphite, anode coke, graphitized anode coke, needle coke, graphitized needle coke, natural graphite powder, synthetic graphite powder, milled versions of any of the afore mentioned types of graphite and combinations thereof. Optionally the aforementioned graphite may be treated to include 0.1-5% pbw of a lithium containing compound prior to use. Exemplary lithium compounds include lithium carbonates, lithium oxides, lithium carbonate esters and combinations thereof. Exemplary percentages by weight (“pbw”) include up to 4%, 3%, 2%, 1% or 0.5%. For such treatment, the graphite may be mixed with a lithium containing solution at temperatures up to 1000° C., preferably at least 500° C.

One embodiment for a suitable particle size includes D₅₀ equals 17-19 microns. Another exemplary embodiment for a suitable particle size is D₁₀ equals 7-12 microns. A further exemplary embodiment is D₉₀ equals 37-45 microns. The embodiments disclosed herein are not limited to any particular particle size to form graphite layer 22. Optionally if so desired any of the aforementioned materials may be shaped, milled, classified, and coated.

Graphite layer 22 may also include an optional binder. The graphite layer 22 may include less than twenty-five (25%) percent binder by weight, even further less than about twenty (20%) percent by weight, even more preferred about ten (10%) or less percent by weight. An example of such binder includes polyvinylidiene fluoride. Further graphite layer 22 is not limited by the type of binder used or by the concentration of such binder.

Silicon layer 24 may be applied to a major surface of graphite layer 22 such that current collector 20 is on one side of graphite layer 22 and silicon layer 24 is on a second major surface of graphite layer 22. Silicon layer 24 may be dry casted or wet casted onto a major surface of the graphite layer 22. Preferably silicon layer 24 is bonded to graphite layer 22.

Silicon layer 24 forms the anode of the battery. Typically silicon layer 24 comprises at least five (5%) percent silicon by weight. Silicon layer 24 may further include at least ten (10%) percent silicon by weight. Optionally, silicon layer includes no more than about twenty-five (25%) percent silicon by weight; further no more than twenty (20%) silicon by weight. Silicon layer 24 may include other materials if so desired. One such material includes graphite. As an optional component, silicon layer 24 will usually contain less than about eighty (80%) percent graphite by weight; in a further embodiment less than about seventy-five (75%); in an even further embodiment less than about sixty (60%) percent by weight.

Optionally, a second graphite layer 32 may be applied to the second major surface of the current collector 20 in the same manner as graphite layer 22. The description of graphite layer 32 may be the same as the description of graphite layer 22. For any particular embodiment of graphite layer 32 of anode 16, graphite layer 32 may be the same or different from graphite layer 22.

An exemplary thickness of graphite layer 32 is at least about 50 microns. Another exemplary thickness is less than about 100 microns. Typically the thickness of the graphite layer is at least about 1 micron to about 150 microns. It is preferred that the thickness of graphite layer 32 is a sufficient thickness to compensate for the volume expansion of the silicon layer 34 during operation of the battery.

Graphite layer 32 is not limited to any particular type of graphite. Graphite layer 32 may include natural graphite, intercalated graphite, exfoliated graphite, anode coke, graphitized anode coke, needle coke, graphitized needle coke, natural graphite powder, synthetic graphite powder, milled versions of any of the afore mentioned types of graphite and combinations thereof.

A second silicon layer 34 may be bonded to second graphite layer 32 of anode 14. Silicon layer 34 may be applied to a major surface of graphite layer 32 such that current collector 20 is on one side of graphite layer 32 and silicon layer 34 is on a second major surface of graphite layer 32. Silicon layer 34 may be dry casted or wet casted onto a major surface of the graphite layer 32. Preferably silicon layer 34 is bonded to graphite layer 32.

Silicon layer 34, if included, comprises at least five (5%) percent silicon by weight. Silicon layer 34 may further include at least ten (10%) percent silicon by weight. Optionally, silicon layer includes no more than about twenty-five (25%) percent silicon by weight; further no more than twenty (20%) silicon by weight. Silicon layer 34 may include other materials if so desired. One such material includes carbon. As an optional component, silicon layer 34 will usual contain less than about eighty (80%) percent carbon by weight; in a further embodiment less than about seventy-five (75%); in an even further embodiment less than about sixty (60%) percent by weight. In another alternate embodiment, a portion to all of the carbon in the silicon layer is replaced with graphite. The same maximum amount of carbon in the silicon layer 34 also applies to the amount of graphite in the silicon layer 34.

An advantage of anode 14 is that it can have a specific capacity retention percentage of at least eighty (80%) percent after 10 or more charge-discharge cycles, even more preferred after 20 or more charge-discharge cycles, and most preferred after 100 or more charge-discharge cycles.

Advantages of using one (1) or both of graphite layers 22 and 32 include that the graphite layer can lead to a reduction in the volume expansion of the silicon layer 24 or 34 it is adjacent. This will reduce/inhibit the tendency for the silicon anode to peel-away from the current collector 20. Another way to view this is that the use of the interlayer will improve the peel strength of the anode.

Another advantage that can be realized by practicing one or more of the embodiments disclosed herein is a reduction in the capacity degradation caused by volume expansion of the silicon-based anodes during charge/discharge cycling (the inherent problem for this type of high capacity anodes) through introduction of a graphite interlayer between the copper current collector and the silicon-based anode. The interlayer can help the silicon anodes better adhere to the current collector; otherwise the silicon anodes will peel off easily from the current collector due to volume expansion during cycling.

In an alternate embodiment, anode 16 may only include current collector 20 and graphite 22 as previously described without silicon layer 24. In a further alternate embodiment, anode 16 may only include current collector 20 with graphite layers 22 and 32 as previously described without either of silicon layers 24 and 34.

The various embodiments described herein can be practiced in any combination thereof. The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the advantages disclosed herein, unless the context specifically indicates the contrary.

### EXAMPLES

The embodiments disclosed herein will now be further described by the below non-limiting examples.

Half-cells of anode with graphite interlayer and without the interlayer were fabricated as follows:

The interlayer was formed by mixing graphite anode powder (D₅₀=17 μm) with carbon black and binder (polyvinylidene fluoride (“PVDF”) in a proportion by weight of about 85% graphite powder, 5% carbon black and 10% binder using N-Methylpyrolidone (NMP) as solvent for dissolving PVDF binder. This was used for the interlayer.

The anode was formed by mixing graphite anode powder (D₅₀=17 μm) with silicon powders (10 μm), carbon black and binder PVDF in a proportion by weight of about 65% graphite powder, 20% silicon powders, 5% carbon black and 10% binder using NMP as solvent for dissolving PVDF binder. This was used for the anode functioning layer.

The mixed slurries were coated on 10 μm thick copper foil (the current collector) using a razor blade and cured at 130° C. One is only coated with the anode functioning layer, and the other is coated with both the interlayer and the anode functioning layer (as shown in the following FIGS. 5 and 2). FIG. 5 includes only the current collector 40 and the anode functioning layer 44 and FIG. 2 includes the current collector 20, the interlayer 22 and the anode functioning layer 24.

The current collector anode assemblies were assembled into half-cells in an argon-filled glove box.

In the half-cells, Li metal was used as the cathode electrode and Celgard 2400 membrane was used as the separator for the two electrodes (the anode and the cathode electrodes). 1.2 M LiPF₆ (lithium hexafluorophosphate) in EC (ethylene carbonate)/ethylmethyl carbonate (EMC) was used as the electrolyte in a volume ratio of 3:7.

Two (2) samples of each type of anode were made and tested.

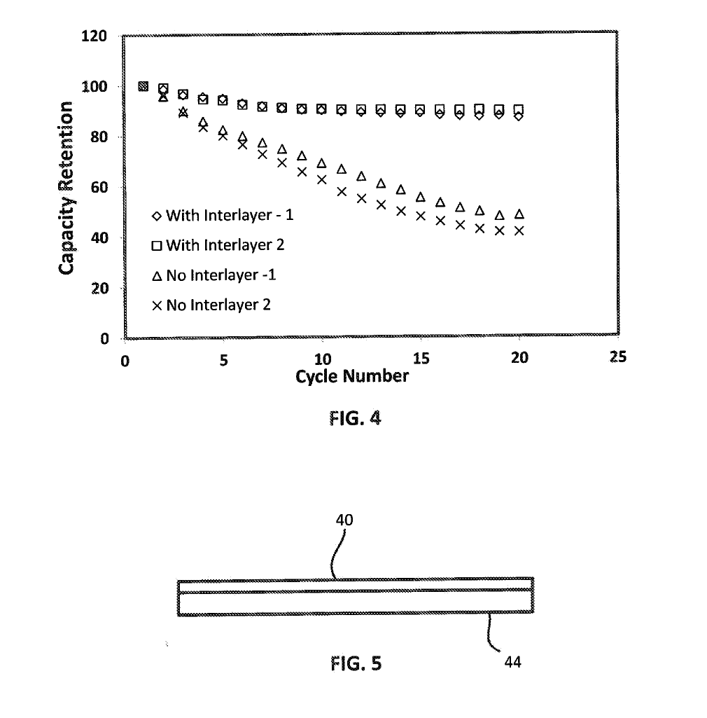

Run charge/discharge tests at 0.1 C were run on the half-cells and the capacity retention (%) versus the cycle number was recorded in FIG. 4. An Arbin Instruments Battery Tester from Arbin Instruments of College Station, Texas was used to conduct such testing.

The above description is intended to enable the person skilled in the art to practice the invention. It is not intended to detail all the possible variations and modifications that will become apparent to the skilled worker upon reading the description. It is intended, however, that all such modifications and variations be included within the scope of the invention that is defined by the following claims.

Thus, although there have been described particular embodiments of the present invention of a new and useful method for making carbon fiber, it is not intended that such references be construed as limitations upon the scope of this invention except as set forth in the following claims. The various embodiments discussed above may be practiced in any combination thereof.

What is claimed is:

1. A battery anode comprising a metallic current collector layer adjacent a first major surface of a graphite layer, a silicon containing anode layer adjacent a second major surface of the graphite layer.

2. The battery anode of claim 1 wherein the metallic current collector bonded to the graphite layer and the silicon containing layer bond to the second major surface of the graphite layer.

3. The battery anode of claim 2 wherein the metallic current collector comprises copper.

4. The battery anode of claim 3 wherein the graphite layer comprises graphite particles of natural graphite, intercalated graphite, exfoliated graphite, anode coke, graphitized anode coke, needle coke, graphitized needle coke, natural graphite powder, synthetic graphite powder, milled versions of any of the afore mentioned types of graphite and combinations thereof.

5. The battery anode of claim 3 wherein a thickness of the graphite layer comprises about 1 to 150 microns.

6. The battery anode of claim 3 wherein the graphite layer thickness comprises a sufficient thickness to compensate for the volume expansion of the silicon layer during operation of the battery.

7. The battery anode of claim 1 wherein the silicon layer comprises at least five percent silicon by weight.

8. The battery anode of claim 1 in a lithium-ion battery.

9. The battery anode of claim 1 further comprising a second graphite layer adjacent the metallic current collector layer, wherein the graphite layer and the second graphite layer in an opposed relationship to each other.

10. The battery anode of claim 9 further comprising a second silicon layer adjacent the second graphite layer.

11. The battery anode of claim 1 having a specific capacity retention percentage of at least eighty percent after 10 or more charge-discharge cycles.

12. A lithium ion battery comprising an anode constructed from copper, graphite and silicon wherein the copper forms the current collector and the silicon forms the anode functioning layer and the graphite interposed between the silicon and the copper.

13. The lithium ion battery of claim 12 wherein the graphite in the form of a layer having a thickness of about 1 to 150 microns.

14. The lithium ion battery of claim 13 wherein the graphite layer comprising particle of synthetic graphite, natural graphite and combinations thereof.

15. The lithium ion battery of claim 14 wherein the graphite layer bonded to the copper current collector.
